(19) United States
(12) Patent Application Publication
(10) Pub. No.: US 2010/0178237 A1
(43) Pub. Date: Jul. 15, 2010

(54) PROCESS FOR RECOVERY OF WATER ISOTOPOLOGUES

(75) Inventors: Ian Richard Bonnettt, Peterborough (CA); Anthony Busigin, Ocala, FL (US)

Correspondence Address: GE HEALTHCARE BIO-SCIENCES CORP.;PATENT DEPARTMENT, 101 CARNEGIE CENTER, PRINCETON, NJ, 08540, US

(73) Assignee: GE HEALTHCARE UK LIMITED, LITTLE CHALFONT (GB)

(21) Appl. No.: 12/663,584

(22) PCT Filed: Jun. 11, 2008
(86) PCT No.: PCT/EP2008/057275

§ 371 Date: Dec. 8, 2009

Related U.S. Application Data
(60) Provisional application No. 60/944,104, filed on Jun. 15, 2007.

(51) Int. Cl. C01B 5/00; C01B 5/02

(52) U.S. Cl. 423/580.2; 423/580.1

(57) ABSTRACT

Disclosed is a process and a system for recovery of isotopologues of water from an aqueous vapour stream optionally containing acidic gases.

### CROSS-REFERENCE TO RELATED APPLICATIONS

This application is a filing under 35 U.S.C. §371 and claims priority to international patent application number PCT/EP2008/057275 filed Jun. 11, 2008, published on Dec. 18, 2008, as WO 2008/152053, which claims priority to U.S. provisional patent application No. 60/944,104 filed on Jun. 15, 2007.

### BACKGROUND TO THE INVENTION

This invention relates generally to the recovery of isotopologues of water and acids from a vapour stream containing water vapour and/or acid gases. More particularly, the invention relates to the recovery of tritium from a vapour stream containing tritiated water vapour and/or acid gases.

Tritium (symbol: T or ³H) is a radioactive isotope of hydrogen of atomic mass 3.016, having a β⁻ particle emission (0.019 MeV maximum) and a half life (T½) of 12.3 years. It is both a product of, and is also used by the nuclear industry, the latter for example, in the production of tritium labelled organic molecules for use in radiotracer studies. As part of a tritium waste treatment and recovery process, there is often a requirement to remove tritium in the form of tritiated water from vapour/gas mixtures which contain non-condensable gases. In order to adequately control the recovery of radioactivity in this stream, the detritiation process must be carried out in a highly efficient manner.

Conventionally, there are a number of methods available for the removal of tritium in the form of tritiated water from gaseous streams:

i) Water vapour can be removed from a gas stream by the use of molecular sieves. Adsorption onto molecular sieves is a reversible process; recovery of the tritiated water can be achieved by heating the molecular sieve to a moderately high temperature (e.g. 250° C. to 350° C.). The process is not usually determined to be cost effective when employed on a large scale. Furthermore, adsorption onto molecular sieve beds requires batchwise operation and the molecular sieves can be susceptible to damage from impurities such as HCl in the vapour stream.
ii) Tritiated water removal from a gaseous stream can also be accomplished by cryogenic trapping using a cold trap, typically cooled to cryogenic temperatures using liquid nitrogen or dry ice, etc. Again, batchwise operation is required with complicated sequencing, and there is an inherent hazard of overpressure introduced by using cryogenic fluids. Regeneration of the cold trap requires addition of an inert (non adsorbable gas) carrier gas which is subsequently chilled to recover liquid water.
iii) There are reports that packed bed or plate columns may be used to contact a gaseous stream containing tritiated water vapour with a cooled water stream (see: Management of Wastes containing Tritium and Carbon-14, Technical Reports Series 421, IAEA (2004), pp 52-53). However, this process dehumidifies the gas stream by lowering the gas temperature and hence its ability to carry water vapour and a large liquid stream with dilute tritium is produced, impacting on further tritium recovery processes. The authors of the report have indicated that the technique is applicable only where a dilute tritium stream is required for direct discharge.

### SUMMARY OF THE INVENTION

In a first aspect, there is provided a process for recovering water isotopologue(s) of interest from a vapour stream the process comprising:

a) bringing a vapour stream comprising aqueous vapour into counter-current contact with an aqueous liquid stream comprising water substantially depleted in said water isotopologue(s) of interest so as to provide an isotopic exchange of said water isotopologue(s) of interest from said vapour stream to said aqueous liquid stream, thereby increasing the concentration of said water isotopologue(s) of interest in said aqueous liquid stream; and
b) withdrawing aqueous liquid enriched with said water isotopologue(s) of interest.

The present invention provides a simpler and more efficient and effective process to recover isotopically labelled water from an aqueous vapour stream containing water isotopologues and optionally exchangeable acidic gases. As disclosed herein, the term “isotopologues” refers to molecular entities that differ only in their isotopic composition (IUPAC Compendium of Chemical Technology, Electronic Version). As an example, water isotopologues may contain one or two deuterium or tritium atoms in place of hydrogen, or an ¹⁷O or ¹⁸O atom in place of ¹⁶O. The method herein described is applicable to the recovery of all isotopologues of water, for example, HTO, T₂O, HDO, D₂O, as well as water containing ¹⁷O or ¹⁸O.

In a preferred embodiment, the water isotopologue(s) of interest comprise oxides of tritium. Thus, in this embodiment, the invention employs a liquid input stream of pure (or substantially pure; i.e. non-tritiated) light water to efficiently strip tritium from an aqueous vapour stream containing exchangeable tritium. The process comprises introducing the aqueous vapour containing oxides of tritium (the input stream) into an exchange column and causing the mixture to flow in a first, preferably upward, direction through the column and in counter-current contact with an aqueous liquid stream containing pure or substantially pure water. Suitably, the liquid water stream is allowed to flow in the opposite (downwards) direction to the vapour stream, thereby providing an isotopic exchange of tritium from the aqueous vapour stream to the aqueous liquid stream. The process efficiently strips tritium from the vapour stream (without creating a relatively large tritium liquid stream) in a continuous manner in the column with the liquid and vapour streams moving in a counter-current manner. The concentration of oxides of tritium in the aqueous vapour phase is thereby reduced, while liquid water enriched with oxides of tritium is withdrawn from the exchange column. The method is particularly useful for the recovery of tritium, by transferring tritium from an aqueous vapour stream into a substantially pure liquid water stream suitable for further processing, e.g. tritium isotope separation, tritium exchange reactions, etc.

In an alternative embodiment, the water isotopologue(s) of interest comprise oxides of deuterium.

In one embodiment, the vapour stream is admixed with an inert carrier gas prior to feeding the mixture into the exchange column. Suitably, the carrier gas is selected such that it does not participate either in the isotopic exchange process, or in a chemical reaction with the components of the vapour input stream. Examples of carrier gas are helium, argon, nitrogen, dry air, or mixtures thereof. Preferably the gas is nitrogen.

In one embodiment, the exchange column is packed with a packing material to facilitate effective mass transfer between the rising gaseous/water vapour phase and the falling aqueous liquid phase. The packing material may be either a random dump, or alternatively structured packing and is employed to improve interfacial liquid to vapour contact and therefore to increase exchange efficiency between the vapour phase and liquid phase. In principle, any suitable packing material may be used, providing that such material is inert under the conditions employed. Examples include glass beads, glass helices, ceramic packing, metal wire mesh packing, metal coils packing and perforated metal strips, and the like.

In a preferred embodiment, the exchange column incorporates static flow mixers which serve to regulate downward flow of liquid water and increase exchange between vapour and liquid phases. Static flow mixers comprise tubular internal column structures of suitable shape and strength to cause mixing and dispersion effects in laminar liquid flow within the exchange column. The arrangement of static flow mixers within the column provides multiple theoretical equilibrium stages between liquid and vapour states within the exchange column. A significant benefit of using static flow mixers is the low pressure drop across the column.

The process may be operated at any suitable operating temperature, provided that the requirement for counter-current isotope exchange between liquid and vapour is satisfied. Typically, the process may be operated at a column temperature of between about 4° C. and about 10° C., preferably between about 4° C. and about 6° C. Preferably, the process is operated at a pressure of between 0.9 bar and 1.0 bar in order to minimise potential for leakage out and to minimise column diameter.

Suitably, the molar aqueous liquid phase water flow downwards in the column is greater than the upward molar flow of the vapour, thereby resulting in tritium transfer by isotopic exchange from the gaseous/vapour stream into the liquid stream. Adding more water will result in higher detritiation performance at the expense of creating more liquid tritiated water to be returned to the process. In a preferred embodiment, the molar liquid phase water flow is set at between 1.1 and 2.0 times the water vapour/acidic gas molar flow up the column. The scale of the apparatus is suitable for the flows required. Tritium in the form of tritiated water, free of dissolved impurities is carried downwards and out of the column; detritiated aqueous vapour residues are removed from the top of the column.

### BRIEF DESCRIPTION OF THE FIGURES

FIG. 1 is a process flow diagram showing the component parts of a water vapour detritiation system according to the invention.

### DETAILED DESCRIPTION OF A PREFERRED EMBODIMENT

A detailed description of a preferred embodiment of the present invention is provided herein. It is to be understood however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure, or manner.

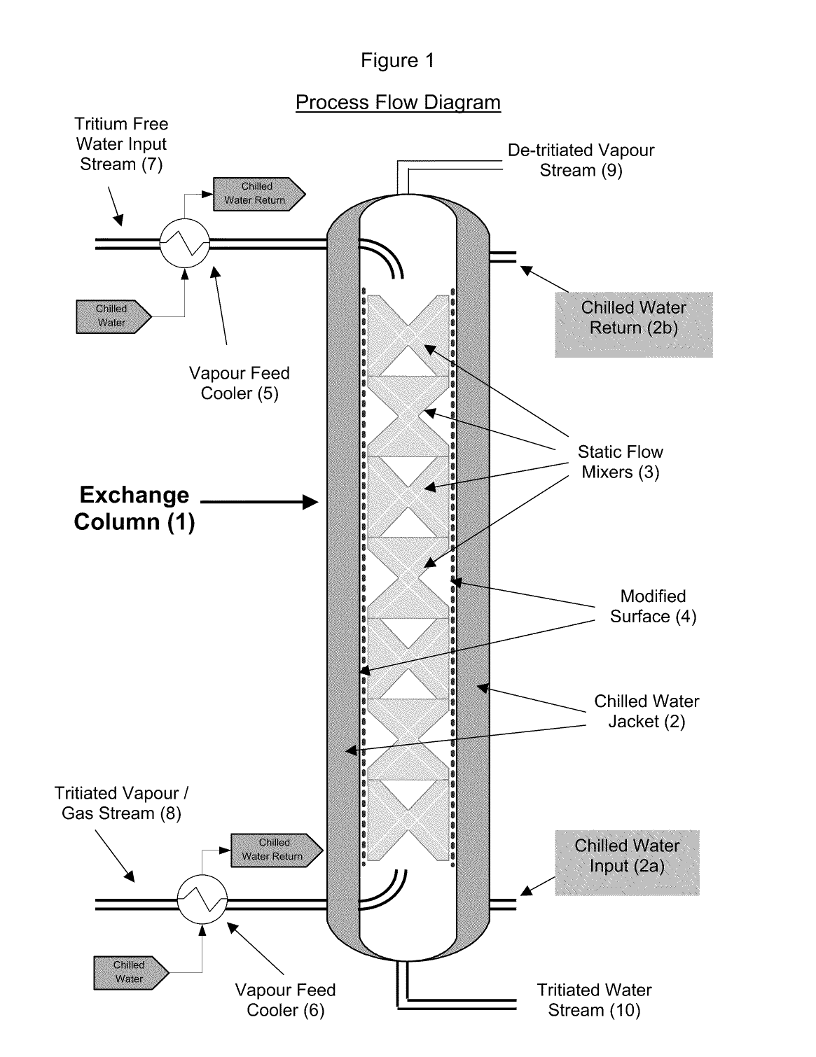

FIG. 1 is a schematic diagram showing a system for the recovery of tritium isotopologues of water according to the invention. The system includes an exchange column (1) having typically a circular cross section. The dimensions of the exchange column are suitably between about 1 meter and about 10 meters in length (height) and between about 0.01 meters and about 2 meters in diameter. To facilitate access to the exchange column (1), preferably the column is fitted with removable upper and lower end pieces which may carry the connecting tubes to enable removal of the de-tritiated vapour stream (9) to waste and tritiated water stream (10) for re-cycling or use. Suitably, the exchange column (1) is formed from a rigid material that is resistant to aqueous-based fluids. For example, the column can be manufactured from a number of metals and alloys such stainless steel, hastelloy, titanium etc. This allows the device to be used in circumstances where acid and corrosive components exist in the vapour feed stream.

In a preferred embodiment, the exchange column incorporates one or more static flow mixers (3) disposed in line with the flow stream. Static flow mixers are employed in the exchange column in order to increase interfacial contact between the liquid and vapour phases moving counter-currently, thereby increasing mass transfer between the two phases and hence increase the number of theoretical equilibrium stages. A static flow mixer comprises a sequence of stationary plates or wires fabricated from an inert material and is either inserted into the exchange column (as a cassette), or fixed to the inner surface of the exchange column. Static flow mixers are readily available in a number of designs and can be fabricated to fit a column of any specified dimensions; see for example those supplied by Sulzer Chemtech AG, Switzerland (SMX, SMXL, SMF, SMR, SMV, SMI and KVM flow mixers). The internal surface of the exchange column may be further modified, for example by rifling, to help promote good mixing of the liquid over the column inner surface and the mass transfer of tritium from the rising gas/vapour. The flow mixers are constructed from a suitable material so as to minimize corrosion.

Surrounding the exchange column (1) is a cooled jacket for cooling the downward liquid and upward vapour flows. The cooling jacket is typically of circular cross-section and is dimensioned to fit outside the exchange column so as to provide the maximum amount of cooling fluid contact with the surface of the exchange column. Fluid inlet (2a) and return (2b) pipes are connected to the cooling jacket through which cooling fluid (usually water cooled to between 4° C. and 10° C.) is circulated.

Alternatively, the exchange column (1) may be packed with a packing material (not shown) so as to provide abundant surface area for mass transfer between the tritium-free water input stream (7) and aqueous liquid and rising gas/vapour inside the column. Suitably, the packing material is either a highly wettable random dump packing or alternatively may be a structured packing In principle, any suitable packing material may be used, providing that such material is inert under the conditions employed. Examples include glass beads, glass helices, ceramic packing, metal wire mesh packing, metal coils packing and perforated metal strips, and the like. For larger dimension columns (e.g. approaching 0.04-2 meters), a wetted wall column using flow mixers is impractical, and a packed column must used in order to achieve reasonable mass transfer performance, due to the large distance from the column wall to the centre of the column.

In operation, a stream of cooled, substantially tritium-free water (7) is fed to the top of the cooled exchange column (1). A cooled, partly non-condensable stream containing tritium oxide vapour (8) and/or acid gases is fed into the bottom of the exchange column. Cooling of the liquid and vapour input streams (7) and (8) can be achieved by any known means, and is typically via heat exchangers (shown as (5) and (6) respectively). The cooled exchange column condenses as much water vapour as possible to maximise tritium removal efficiency. The remaining vapour and non-condensable gases then pass up through the column from the bottom, with substantially tritium-free water passing counter-currently down the column from the top. Tritiated water vapour and tritium in acid gas form in the feed stream is removed by isotopic exchange and is collected in the liquor which flows under gravity to the bottom of column for recovery to a suitable process (10). The detritiated vapour stream then leaves the top of the column and can be discharged to a suitable effluent stream (9), substantially free of tritium in comparison with the original vapour/gas stream.

From a shutdown state with the exchange column and heat exchangers dry, the chilled water flows are established to the heat exchangers and then clean substantially tritium-free water flow to the top of the exchange column is started. Once the correct liquid flow has been established the column is ready to accept the vapour/gas stream. The column is able to operate continuously with no adjustment to water flow being necessary, unless the vapour/gas flow stream or tritium content significantly increases. Detritiation performance can be maintained in these circumstances by increasing the water stream flow down the column.

For shutdown, the tritiated vapour/gas stream flow to the column is stopped. The water stream is allowed to continue flowing down the exchange column, which assist in flushing any residual tritium from the column. After a suitable interval, the water stream flow to the top of the column is stopped, and then the chilled water flow to heat exchangers is stopped. A dry gas, such as nitrogen, may be fed to the bottom of the column to remove residual moisture in the column. After sufficient drying time the dry gas flow is stopped and the column is in the shutdown state.

In one example according to the process, tritiated water is stripped from a hydrochloric acid/HTO vapour stream which is allowed to flow up the column and is caused to come into counter-current contact with an input stream of substantially tritium free water. The exchangeable tritium atom fraction in the gas/vapour stream is significantly higher than the input stream of water. The tritium-containing water vapour and hydrochloric acid vapour undergo isotopic exchange according to the following isotope exchange reaction:

HTO₍ᵥₐₚ₎+H₂O_{(liq)}=H₂O₍ᵥₐₚ₎+HTO_{(liq)}

The tritiated HCl exchange reaction is as follows:

TCl₍ᵥₐₚ₎+H₂O_{(liq)}=HCl₍ᵥₐₚ₎+HTO_{(liq)}

The tritium concentration of the vapour effluent is low enough for discharge to the environment, or to meet the requirements of a specific application. According to the process described, a vapour detritiation factor (liquid tritium in/liquid tritium out) of at least 5000 may be obtained with suitable column height. The column height and water vapour to liquid flow ratio may be adjusted to produce any desired liquid detritiation factor, from 1 to 10,000 or even greater. The column may have any number of theoretical equilibrium stages, given sufficient column height. The process is simple and reliable, having no net chemical reactions, operating at slightly lower than room temperature, and typically below atmospheric pressure.

While FIG. 1 shows only one vapour detritiation column (1) employed in the process of the invention, it is to be understood that in practice, two or more columns may be employed in parallel so as to optimise separation of tritiated water from an impure feedstock of tritium-containing water vapour. Alternatively, two or more columns may be employed in series to increase the recovery of tritium. Likewise, the process according to the present invention may be operated batchwise, or alternatively in a continuous process. Preferably, the process is a continuous process. Furthermore, the process is compatible with any downstream conversion process to convert recovered tritiated water into elemental hydrogen by such means as electrolysis, water decomposition by water gas shift reactor (i.e. palladium membrane reactor) or a hot metal bed reactor.

### ADVANTAGES OF THE INVENTION

i) The present invention provides a continuous, simple and inherently safe process for the detritiation of aqueous vapour streams than batchwise processes such as molecular sieve beds or cryogenic trapping. The process described herein utilises a lower pressure drop through the exchange column in comparison with packed bed adsorbers or packed column arrangements at higher vapour flow rates. Thus, there is less back pressure on upstream systems, which is inherently safer (i.e. operating tritium containing systems at lower pressures). In addition, for certain applications where the vapour/gas stream is being generated from a system with a potential for rapid pressure changes (e.g. a thermal oxidiser) the open flow path of this invention can provide a low pressure drop relief path. Furthermore, the invention requires a lower tritiated liquid inventory than that with a direct absorption packed bed or column, due to the lower liquid hold up in the column design. Chilling the feed streams and the column maximises the recovery of water vapour by condensation in conjunction to recovery of non-condensable tritium species such as TCl by operating at more favourable absorption conditions at lower temperatures.

The drawing constitutes a part of this specification and includes an exemplary embodiment to the invention, which may be embodied in various forms. It is to be understood that in some instances various aspects of the invention may be shown exaggerated or enlarged to facilitate an understanding of the invention.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. A process for recovering water isotopologue(s) of interest from a vapour stream the process comprising:
a) bringing a vapour stream comprising aqueous vapour into counter-current contact with an aqueous liquid stream comprising water substantially depleted in said water isotopologue(s) of interest so as to provide an isotopic exchange of said water isotopologue(s) of interest from said vapour stream to said aqueous liquid stream, thereby increasing the concentration of said water isotopologue(s) of interest in said aqueous liquid stream; and
b) withdrawing aqueous liquid enriched with said water isotopologue(s) of interest.

2. The process of claim 1, wherein said water isotopologue(s) of interest comprise oxides of tritium.

3. The process of claim 1, wherein said water isotopologue(s) of interest comprise oxides of deuterium.

4. The process of claim 1, further wherein said aqueous vapour stream comprises acidic gases.

5. The process of claim 1, wherein the stream of water vapour introduced into the column is admixed with a carrier gas.

6. The process of claim 1, wherein said exchange column is fitted with one or more static mixers to increase interfacial liquid to vapour contact.

7. The process of claim 1, wherein said exchange column is fitted with a packing to increase interfacial liquid to vapour contact.

8. The process of claim 1, wherein said process is a continuous process.
